(19) United States
(12) Patent Application Publication
(10) Pub. No.: US 2016/0170729 A1
(43) Pub. Date: Jun. 16, 2016

(54) METHOD AND DEVICE FOR INSTALLING SMART APPLIANCE

(71) Applicant: Xiaomi Inc., Beijing (CN)

(72) Inventors: Yang WANG, Beijing (CN); Qiang FU, Beijing (CN); Enxing HOU, Beijing (CN)

(73) Assignee: Xiaomi Inc.

(21) Appl. No.: 14/872,219

(22) Filed: Oct. 1, 2015

Related U.S. Application Data
(63) Continuation of application No. PCT/CN2015/080667, filed on Jun. 3, 2015.

(30) Foreign Application Priority Data
Dec. 16, 2014 (CN) 201410835745.X

(51) Int. Cl. G06F 9/445; G06F 9/44; G06F 3/0482; G06F 3/0481

(52) U.S. Cl. CPC G06F 8/61; G06F 3/04817; G06F 9/4446; G06F 3/0482

(57) ABSTRACT

A method for installing a smart appliance is disclosed. The method is performed by a server device and includes: detecting whether a first confirmation icon is selected on a user interface of an application program on a terminal device; after detecting that the first confirmation icon is selected, determining installation guiding information for a smart appliance associated with the first confirmation icon; and sending the installation guiding information to the terminal device to be displayed by the application program.

### CROSS-REFERENCE TO RELATED APPLICATIONS

This application is a Continuation Application of International Application No. PCT/CN2015/080667, filed Jun. 3, 2015, which is based upon and claims priority to Chinese Patent Application No. 201410835745.X, filed Dec. 26, 2014, the entire contents of all of which are incorporated herein by reference.

### TECHNICAL FIELD

The present disclosure generally relates to the field of electronic technologies and, more particularly, to a method and device for installing of a smart appliance.

### BACKGROUND

Generally, exquisite appearance and reliable quality are important to electronic products. In addition to that, a concise specification may allow a user to use an electronic product without much learning effort. In the related art, a user generally needs to read a paper specification to learn how to install and use an electronic product after the user purchases the product. The paper specification may not reduce complexity of installation of the electronic product for the user, and degrade user experience.

### SUMMARY

According to a first aspect of the present disclosure, there is provided a method for installing a smart appliance. The method is performed by a server device and includes: detecting whether a first confirmation icon is selected on a user interface of an application program on a terminal device; after detecting that the first confirmation icon is selected, determining installation guiding information for a smart appliance associated with the first confirmation icon; and sending the installation guiding information to the terminal device to be displayed by the application program.

According to another aspect of the present disclosure, there is provided a device for installing a smart appliance. The device includes a processor; and a memory for storing instructions executable by the processor. The processor is configured to perform: detecting whether a first confirmation icon is selected on a user interface of an application program on a terminal device; after detecting that the first confirmation icon is selected, determining installation guiding information for a smart appliance associated with the first confirmation icon; and sending the installation guiding information to the terminal device to be displayed by the application program.

According to a further aspect of the present disclosure, there is provided a non-transitory computer-readable storage medium storing instructions that, when being executed by a processor of a server, cause the server to perform: detecting whether a first confirmation icon is selected on a user interface of an application program on a terminal device; after detecting that the first confirmation icon is selected, determining installation guiding information for the smart appliance associated with the first confirmation icon; and sending the installation guiding information to the terminal device to be displayed by the application program.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1A is a flow chart of a method for installing a smart appliance, according to an exemplary embodiment.

FIG. 1B is a schematic diagram of a user interface for installing a smart appliance, according to an exemplary embodiment.

FIG. 1C is a flow chart of a method for determining installation guiding information, according to an exemplary embodiment.

FIG. 2A is a flow chart of a method for installing a smart appliance, according to an exemplary embodiment.

FIG. 2B is a schematic diagram of a user interface for installing a smart appliance, according to an exemplary embodiment.

FIG. 3 is a flow chart of a method for installing a smart appliance, according to an exemplary embodiment.

FIG. 4 is a block diagram of an apparatus for installing a smart appliance, according to an exemplary embodiment.

FIG. 5 is a block diagram of an apparatus for installing a smart appliance, according to an exemplary embodiment.

FIG. 6 is a block diagram of a device for installing a smart appliance, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

In exemplary embodiments of the present disclosure, a smart appliance may communicate with a terminal device through a wired or wireless communication interface. The smart appliance may be, for example, a smart socket, a smart camera, a smart lamp, a smart air purifier, a smart lighting, a smart coffee machine, a computer, a security system, a video and audio system, a smart water heater, a smart air conditioner, or the like. A terminal device may be a smart phone, a tablet computer, a desktop computer, a laptop computer, etc.

Consistent with the present disclosure, a smart appliance application program can run on the terminal device. The smart appliance application program may include an user interface for a user to perform operations, such as monitoring, managing, controlling, of one or more smart appliances. In some embodiments, the smart appliance application program may also include a purchase interface for the user to browse, or purchase, or save information related to smart appliances. In some embodiments, the interface for the user to perform operations may include a list of smart appliances operable or possessed by the user. For example, if the user can manage or possess a smart air purifier, the smart air purifier can appear in the list of smart appliances. In addition, the list of smart appliances may also display current operation states of smart appliances.

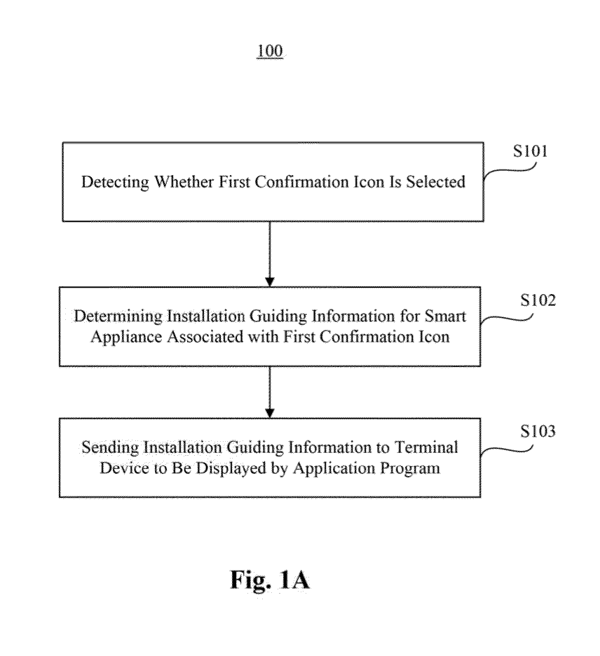

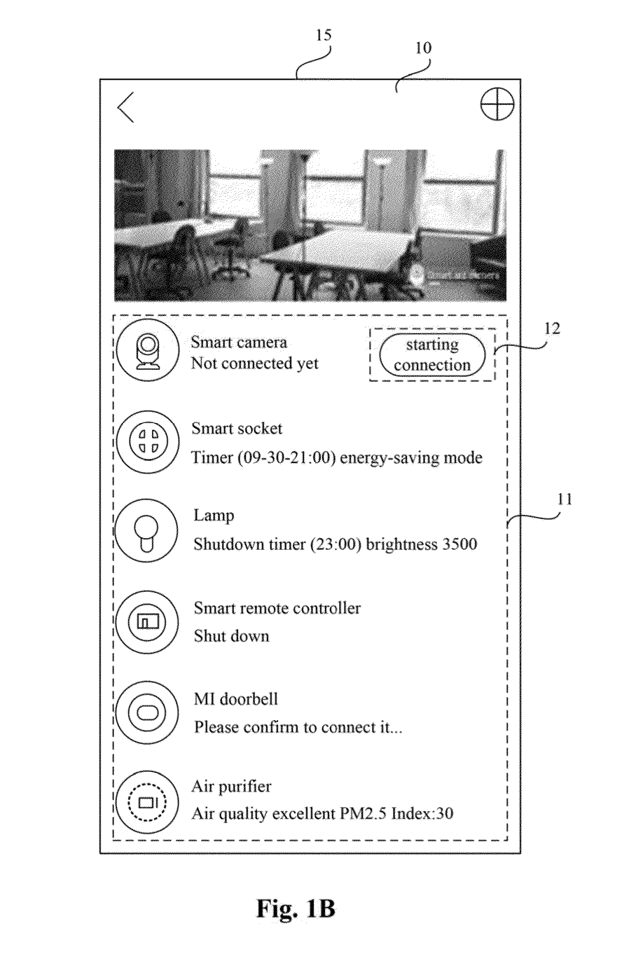

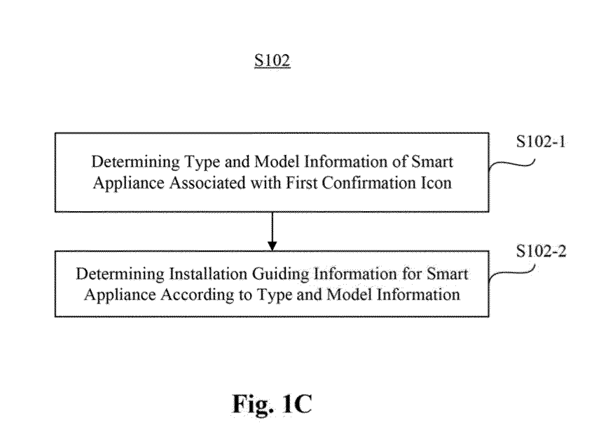

FIG. 1A is a flow chart of a method 100 for installing a smart appliance, according to an exemplary embodiment. For example, the method 100 may be used in a server device. As shown in FIG. 1A, the method 100 includes steps S101-S103.

In step S101, the server device detects whether a first confirmation icon is selected on a user interface of a smart appliance application program of a terminal device. The selection may be made by a user in a plurality of ways, such as a touch on the icon by one or more fingers, a stylus, or a click on a keyboard or tracking ball.

FIG. 1B shows a schematic diagram of a user interface 10 of a terminal device 15 for installing a smart appliance, according to an exemplary embodiment. The user interface 10 includes a list 11 of smart appliances which a user currently controls or possesses. In one embodiment, referring to FIG. 1B, after the user purchases a smart appliance (for example, a smart camera) through a purchase interface of the smart appliance application program, the user may select a first confirmation icon 12 (“starting connection”) associated with the smart camera. A message of the user selecting the first confirmation icon 12 may be sent from the terminal device 15 and received by the server device through wireless or wired communication.

In step S102, after detecting that the first confirmation icon 12 is selected, the server device determines installation guiding information for the smart appliance associated with the first confirmation icon 12. The installation guiding information may be presented as one or more pages displayed on the user interface 10.

In some embodiments, the user may purchase different types of smart appliances or different models of the same type of smart appliances through the purchase interface of the smart appliance application program. Each of the different types or different models of smart appliances may need a different installation program. Accordingly, correct installation guiding information associated with the smart appliance can be determined based on the selection of the first confirmation icon 12, thereby the installation guiding information can match the smart appliance which the user wants to install.

In some embodiment, the server may use a user identification (ID) to determine smart appliances of the user, which can be displayed in the list 11 of smart appliances in the user interface 10. The server may monitor each smart appliance in the list 11 and may determine a type and a model of the smart appliance to be installed. In other embodiments, the server may also determine the type and the model of the smart appliance to be installed through type and model information carried by the message indicating the selection of the first confirmation icon 12.

In step S103, the installation guiding information is sent to the terminal device, to be displayed by the smart appliance application program.

In one exemplary embodiment, when the server detects that the first confirmation icon 12 is selected, since the first confirmation icon 12 is associated with the smart camera, the server may send the installation guiding information of the smart camera to the terminal device so that the user interface 10 for smart appliances may display the installation guiding information. The server may also control the progress of the installation guiding information displayed in the user interface 10, according to the progress of installing the smart camera.

In the embodiments illustrated above, by detecting that the first confirmation icon is selected, installation guiding information for the smart appliance can be determined. The smart appliance can be installed according to the installation guiding information, eliminating the need of the user reading a paper specification. Thus, the installation process of the smart appliance may be simplified, and the user experience in installing the smart appliance may be improved.

In some embodiments, referring to FIG. 1C, the determining of the installation guide information (step S102) may include steps S102-1 and S102-2.

In step S102-1, the server determines type and model information of the smart appliance associated with the first confirmation icon 12. In step S102-2, the server determines the installation guiding information for the smart appliance according to the type and model information.

Since the purchase interface of the smart appliance application program may provide different types of, or different models of the same type of, smart appliances for the user, the user needs to acquire the type and model information of a smart appliance after the user acquires and wishes to install the smart appliance. As the type and model information is associated with the first confirmation icon 12, the server device may determine the correct installation guiding information based on the user's selection of the first confirmation icon 12. For example, as shown in FIG. 1B, after the user purchases the smart camera and selects the first confirmation button 12, the server may determine installation guiding information matching the smart camera. That is, the server device may determine that the smart appliance to be installed is a smart camera, and determine a type and a model of the smart camera, so as to allow the user to complete the installation of the smart camera according to the installation guiding information for the smart camera.

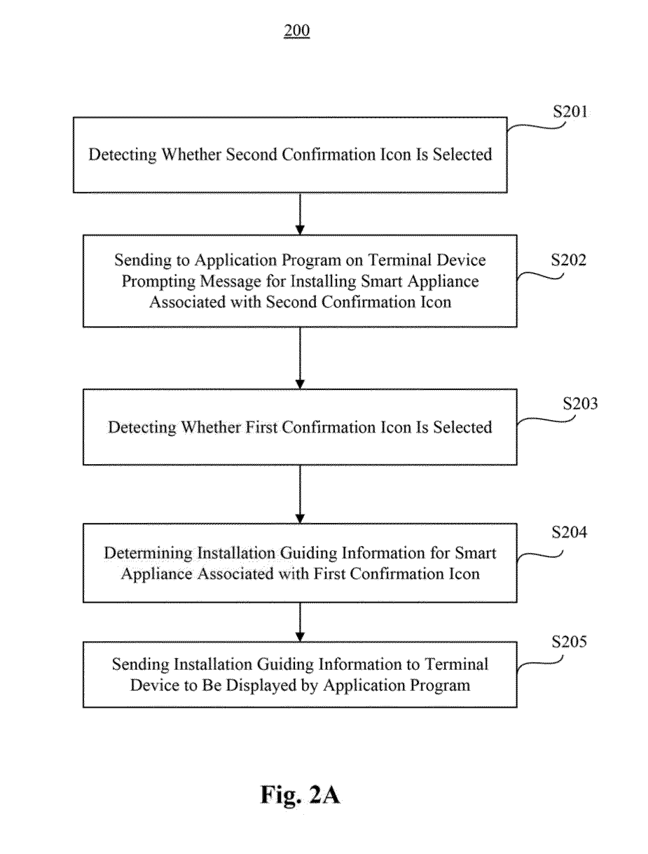

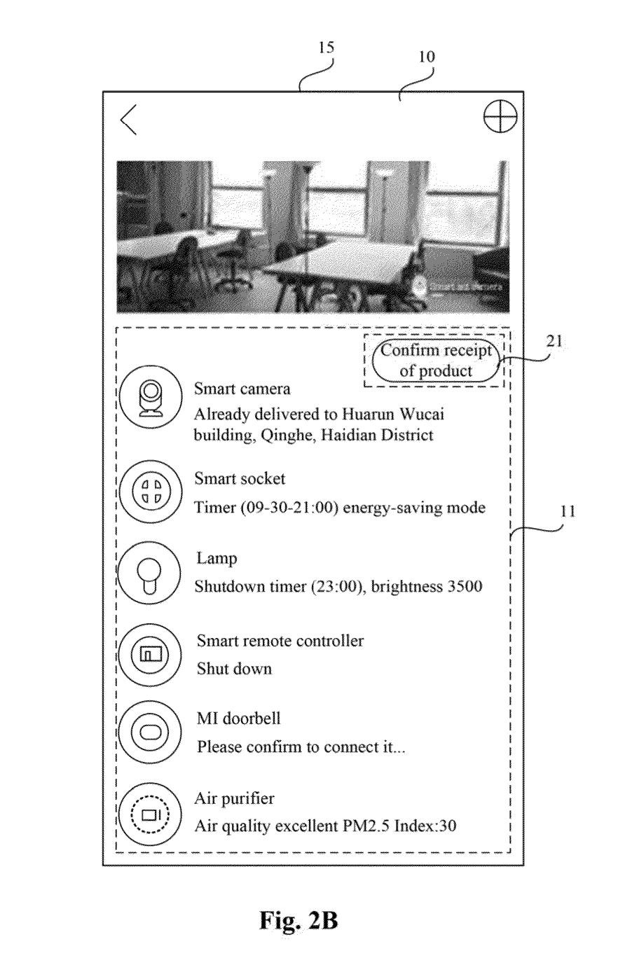

FIG. 2A is a flow chart of a method 200 for installing a smart appliance according to an exemplary embodiment. For example, the user wants to install a smart appliance after the user has purchased the smart appliance through the purchase interface of a smart appliance application program. The method 200 may be performed by a server device. As shown in FIG. 2A, the method 200 includes the following steps.

In step S201, the server device detects whether a second confirmation icon is selected on a user interface of the smart appliance application program on a terminal device. The selection may be made by a user in a plurality of ways, such as a touch on the icon by one or more fingers, a stylus, or a click on a keyboard or tracking ball.

FIG. 2B is a schematic diagram of the user interface 10 displaying a second confirmation icon 21 on the terminal device 15, according to an exemplary embodiment. Similar to the above description in connection with FIG. 1B, the user interface 10 includes the list 11 of smart appliances. In one embodiment, referring to FIG. 2B, after the user purchases the smart camera through the purchase interface of the smart appliance application program and the smart camera has been delivered to the user, the server device causes a message, e.g., “Already delivered to Huarun Wucai building, Qinghe, Haidian District,” to be displayed for the smart camera on the list 11. Further, the server causes the terminal device 15 to display the second confirmation icon 21, e.g., “Confirm receipt of product,” next to the smart camera on the list 11. The user may confirm he/she has received the product by selecting the second confirmation icon 21.

In step S202, after detecting that the second confirmation icon 12 is selected, the server device send to the smart appliance application program on the terminal device a prompting message for installing the smart appliance associated with the second confirmation icon 12.

In one embodiment, when the user selects the second confirmation icon 21 (FIG. 2B), the server device sends a prompting message to the terminal device 15 to be displayed on the first confirmation icon 12 (FIG. 1B). For example, “starting connection” may be displayed on the first confirmation icon 12 to prompt the user that the smart appliance may be installed.

In step S203, the serve detects whether the first confirmation icon 12 is selected on the user interface 10 of the smart appliance application program on the terminal device, according to the prompting message.

In step S204, after detecting that the first confirmation icon 12 is selected, the server device determines installation guiding information for the smart appliance associated with the first confirmation icon 12. The installation guiding information may be presented as one or more pages displayed on the user interface 10.

In step S205, the server device sends the installation guiding information to the terminal device to be displayed by the smart appliance application program.

Steps S203 to S205 of the method 200 are similar to steps S101 to S103 of the method 100, respectively.

In the embodiments illustrated above, when it is detected that the second confirmation button 21 is selected, a prompting message is sent to the smart appliance application program of the terminal device. The user can be informed that the smart appliance may be installed. When it is detected that the first confirmation icon 12 is selected, installation guiding information for the smart appliance associated with the first confirmation icon 12 is determined. The user may install the smart appliance according to the installation guiding information, eliminating the need of the user reading a paper specification. Thus, the installation of the smart appliance may be simplified, and the user experience in installing the smart appliance may be improved.

In some embodiments, the installation guiding information may be determined through the steps discussed above with respect to FIG. 1C, the details of which will not be repeated here.

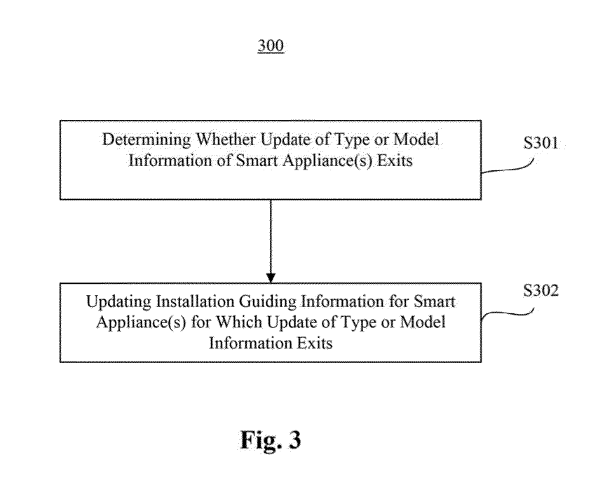

FIG. 3 is a flow chart of a method 300 for updating installation guiding information, consistent with embodiments of this disclosure. The method 300 may be performed by a server device. As shown in FIG. 3, the method 300 includes the following steps.

In step S301, the server device determines whether an update of type or model information of smart appliances exits.

In step S302, if it is determined that the update exits, the server device updates installation guiding information for the smart appliance(s) for which the update of type or model information exits.

In some embodiments, as types and models of the smart appliances increase or are updated, the server device may provide more different types or models of smart appliances to users through the purchase interface of the smart appliance application program. When there is a new model of smart appliances, the installation guiding information may be updated according to the type and the model. Accordingly, when a user purchases a latest smart appliance, the user may install the smart appliance through the installation guiding information.

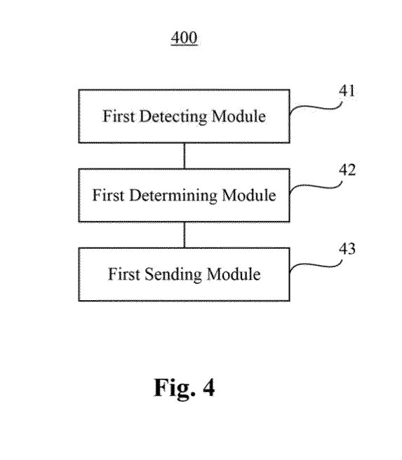

FIG. 4 is a block diagram of an apparatus 400 for installing a smart appliance according to an exemplary embodiment. For example, the apparatus 400 may be a part of a server device or the whole server device. As shown in FIG. 4, the apparatus 400 includes a first detecting module 41, a first determining module 42, and a first sending module 43.

The first detecting module 41 is configured to detect whether a first confirmation icon is selected on a user interface of a smart appliance application program on a terminal device.

The first determining module 42 is configured to, upon the first detecting module 41 detects that the first confirmation icon is selected, determine installation guiding information for the smart appliance associated with the first confirmation icon.

The first sending module 43 is configured to send the installation guiding information determined by the first determining module 42 to the terminal device to be displayed by the smart appliance application program.

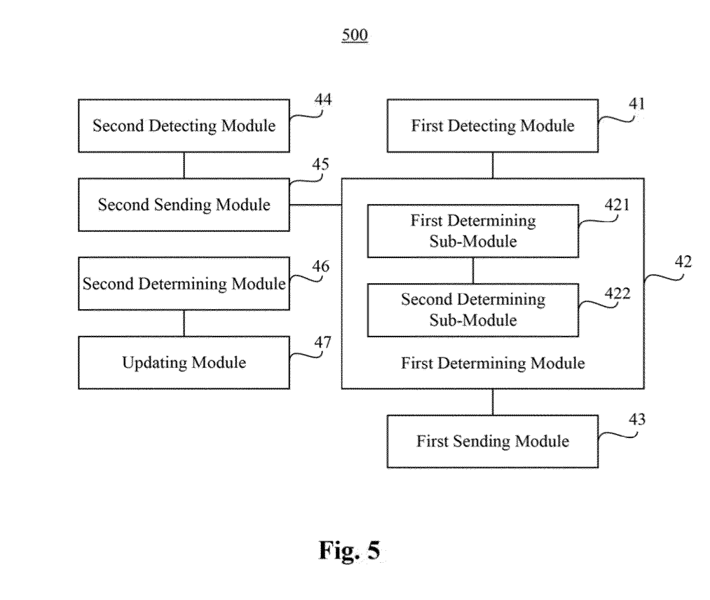

FIG. 5 is a block diagram of an apparatus 500 for installing a smart appliance, according to an exemplary embodiment. For example, the apparatus 500 may be a part of a server device or the whole server device. As shown in FIG. 5, the apparatus 500 includes the first detecting module 41, the first determining module 42, and the first sending module 43 (FIG. 4).

In exemplary embodiments, referring to FIG. 5, the first determining module 42 may include a first determining sub-module 421 and a second determining sub-module 422.

The first determining sub-module 421 is configured to determine type and model information of the smart appliance associated with the first confirmation icon selected by the user, which is detected by the first detecting module 41.

The second determining sub-module 422 is configured to determine the installation guiding information for the smart appliance according to the type and model information determined by the first determining sub-module 421.

In some embodiments, the apparatus 500 may further include a second detecting module 44 and a second sending module 45.

The second detecting module 44 is configured to monitor whether a second confirmation icon is selected on the user interface.

The second sending module 45 is configured to, upon the second detecting module 45 detects that the second confirmation icon is selected, send to the smart appliance application program a prompting message for installing the smart appliance associated with the second confirmation icon, so as to prompt the user to select the first confirmation icon according to the prompting message.

In some embodiments, the apparatus 500 may further include a second determining module 46 and an updating module 47.

The second determining module 46 is configured to determine whether an update of type and model information of smart appliance(s) exits.

The updating module 47 is configured to, if the second determining module 46 determines that an update of the type and model information of smart appliance(s) exits, update the installation guiding information for the smart appliance(s) of which the update of the type information and model information exits, so that the first determining module 42 may determine the correct installation guiding information for the smart appliance associated with the first confirmation icon.

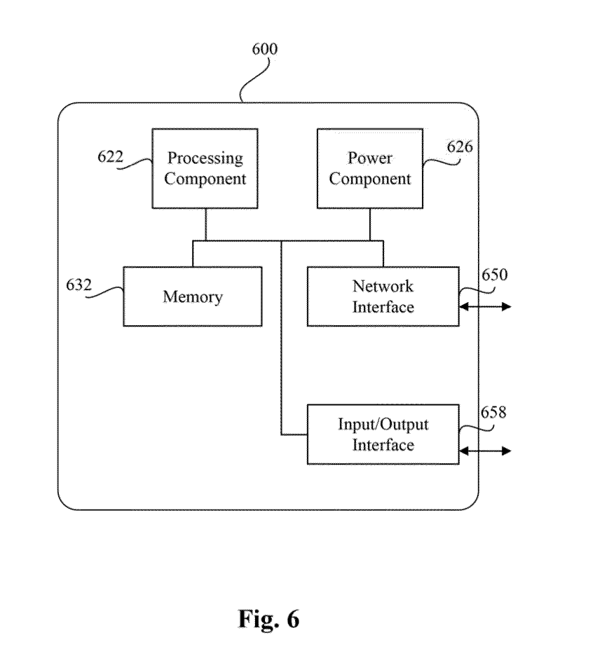

FIG. 6 is a block diagram of a device 600 for installing a smart appliance, according to an exemplary embodiment. For example, the device 600 may be a server device consistent with the embodiments of this disclosure. Referring to FIG. 6, the device 600 may include a processing component 622, which further includes one or more processors and storage resources, represented by a memory 632, for storing instructions such as an application program executable by the processing component 622. The memory 632 may be a non-transitory computer-readable storage medium. The application program stored in the memory 632 may include instructions for various modules. In addition, the processing component 622 is configured to execute instructions to perform the above methods for installing a smart appliance.

The device 600 further includes a power component 626 configured to perform power management for the device 600, a wired or wireless network interface 650 configured to connect the device 600 to network, and an input/output (I/O) interface 658. The device 600 may be operated based on an operating system such as Windows Server™, Mac OS X™, Unix™, Linux™, FreeBSD™ or the like stored in the memory 632.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for installing a smart appliance, the method being performed by a server device and comprising:
detecting whether a first confirmation icon is selected on a user interface of an application program on a terminal device;
after detecting that the first confirmation icon is selected, determining installation guiding information for a smart appliance associated with the first confirmation icon; and
sending the installation guiding information to the terminal device to be displayed by the application program.

2. The method according to claim 1, wherein the determining of the installation guiding information comprises:
determining type and model information of the smart appliance associated with the first confirmation icon; and
determining, according to the type and model information, the installation guiding information for the smart appliance.

3. The method according to claim 1, further comprising:
detecting whether a second confirmation icon is selected on the user interface; and
after detecting that the second confirmation icon is selected, sending to the application program on the terminal device a prompting message for installing the smart appliance associated with the second confirmation icon, so as to prompt a user to select the first confirmation icon.

4. The method according to claim 1, further comprising:
determining whether an update of type or model information of the smart appliance exits; and
if it is determined that the update exits, updating installation guiding information for the smart appliance.

5. A device for installing a smart appliance, comprising:
a processor; and
a memory for storing instructions executable by the processor;
wherein the processor is configured to perform:
detecting whether a first confirmation icon is selected on a user interface of an application program on a terminal device;
after detecting that the first confirmation icon is selected, determining installation guiding information for a smart appliance associated with the first confirmation icon; and
sending the installation guiding information to the terminal device to be displayed by the application program.

6. The device according to claim 5, wherein in determining the installation guiding information, the processor is configured to perform:
determining type and model information of the smart appliance associated with the first confirmation icon; and
determining the installation guiding information for the smart appliance according to the type and model information.

7. The device according to claim 5, wherein the processor is further configured to perform:
detecting whether a second confirmation icon is selected on the user interface; and
after detecting that the second confirmation icon is selected, sending to the application program on the terminal device a prompting message for installing the smart appliance associated with the second confirmation icon, so as to prompt a user to select the first confirmation icon.

8. The device according to claim 5, wherein the processor is further configured to perform:
determining whether an update of type or model information of the smart appliance exits; and
if it is determined that the update exits, updating installation guiding information for the smart appliance.

9. A non-transitory computer-readable storage medium storing instructions that, when being executed by a processor of a server, cause the server to perform:
detecting whether a first confirmation icon is selected on a user interface of an application program on a terminal device;
after detecting that the first confirmation icon is selected, determining installation guiding information for the smart appliance associated with the first confirmation icon; and
sending the installation guiding information to the terminal device to be displayed by the application program.

10. The non-transitory computer-readable storage medium according to claim 9, wherein the determining of the installation guiding page comprises:
determining type and model information of the smart appliance associated with the first confirmation icon; and
determining, according to the type and model information, the installation guiding information for the smart appliance.

11. The non-transitory computer-readable storage medium according to claim 9, wherein the server is further caused to perform:
detecting whether a second confirmation icon is selected on the user interface; and
after detecting that the second confirmation icon is selected, sending to the application program on the terminal device a prompting message for installing the smart appliance associated with the second confirmation icon, so as to prompt a user to select the first confirmation icon.

12. The non-transitory computer-readable storage medium according to claim 9, wherein the server is further caused to perform:
determining whether an update of type or model information of the smart appliance exits; and
if it is determined that the update exits, updating installation guiding information for the smart appliance.
